(19) United States
(12) Patent Application Publication
(10) Pub. No.: US 2025/0314229 A1
(43) Pub. Date: Oct. 9, 2025

(54) Bicycle-Like Pressure-Differential Engine Apparatus

(71) Applicant: Vitalii Markov, New York, NY (US)

(72) Inventor: Vitalii Markov, New York, NY (US)

(21) Appl. No.: 18/625,421

(22) Filed: Apr. 3, 2024

(51) Int. Cl. F03B 17/02

(52) U.S. Cl. CPC F03B 17/04; F03B 17/02; F03G 7/04; F03B 9/00

(57) ABSTRACT

The present disclosure provides a bicycle-like pressure-differential engine apparatus that takes advantage of the pressure gradient that occurs with changes in height due to gravitational pull in a fluid environment to generate energy. A closed chain of compressible elements wrapped around and coupled to a pair of toothed vertical wheels having aligned axes of rotation is positioned in the same vertical plane. A rigid frame structure holds the wheels at a set distance from one another and a coupling assembly links the rotational motion of the two vertical wheels, the coupling assembly comprising a set of ratioed gears. The compressible elements at the top experience a different pressure to those at the bottom, causing expansion and contraction of the chain at different points along its length, except for those elements trapped between the teeth of the wheels, which in turn generates thrust and rotates the wheels.

### FIELD OF INVENTION

The present invention relates generally to generator systems. More specifically, the present invention relates to a pressure-differential engine apparatus capable of producing energy purely from gradients in ambient fluid density and gravitational pull.

### BACKGROUND

In the quest for sustainable and efficient energy generation, the exploration of alternative energy sources and innovative mechanisms has become a priority. Traditional energy generation methods often rely on non-renewable resources, which are dwindling at an alarming rate, or on renewable sources that face limitations due to environmental conditions, availability, and technological constraints. This has spurred significant interest in devising methods that can harness energy from readily available, yet often overlooked, natural phenomena.

One such phenomenon is the pressure gradient that occurs in fluid environments due to changes in height influenced by gravitational pull. Conventional systems designed to exploit this gradient for energy generation have been hampered by a range of limitations. For instance, many existing technologies require specific environmental conditions to operate efficiently or are burdened with mechanical complexities that hinder their effectiveness and scalability. Furthermore, the efficiency of these systems often decreases significantly outside of their optimal operating conditions, limiting their applicability across diverse environments.

Moreover, the mechanical designs of existing solutions frequently do not allow for the flexible adaptation to varying pressure differentials, which can greatly affect their performance. These systems also tend to have a high dependency on the material properties of their components, which can lead to increased wear and tear, higher maintenance costs, and reduced operational lifetimes. Additionally, the integration of these technologies into existing infrastructure poses significant challenges, further restricting their widespread adoption.

Recognizing these shortcomings, there has been a concerted effort to develop a more versatile and efficient system capable of exploiting the energy potential inherent in fluid pressure gradients. The envisioned solution aims to overcome the constraints of current technologies by introducing a novel mechanism that is both adaptable to various environmental conditions and capable of generating energy more efficiently and reliably. This pursuit has culminated in the development of a pressure-differential engine apparatus designed to harness the untapped potential of pressure gradients in fluid environments to generate energy, promising a significant leap forward in the field of renewable energy generation.

Pressure-differential engines exist in the prior art. For example, WO2014116692A1 describes an engine that utilizes hydrostatic pressure differentials found or created in various liquids, gases or solutions via a two-stroke piston cycle power generating system, wherein the actions of the pistons perform work or replenish working fluid from a lower head to a higher head, and can be utilized to generate power, pump fluids, or perform work, for example. Multiple power generating systems are interconnected to provide continuous and constant power generation through a penstock and turbine system.

Another example of a pressure differential engine in the prior art is found in WO2021145779A1, which describes a device for transforming energy in the form of work of a piston acting against a pressure in a liquid/fluid, into electrical energy, said liquid/fluid forming a surface towards the atmosphere, said device comprising a non-perforated pipe being open at its two ends and being equipped internally with a moving piston, said device being located with one end above the surface of the fluid and with its other end descending into said fluid to form a pressure difference between the pressure exerted on the piston by the fluid at the top of the pipe and the pressure exerted on the piston from the hydrostatic pressure of the fluid at a lower location of the pipe, the location of said piston being shifted by the addition or removal of fluid into and out of the pipe at the top of the fluid, said piston being connected to an electrical generator for generating power equal to the work difference between the work executed by the fluid at the top pressure of the pipe and the work done by the piston against the pressure at the bottom of the pipe.

While the solutions proposed in the prior art are capable of producing net positive energy, neither of the disclosed systems, nor any prior art, discloses a pressure-differential engine which is capable of remaining self-powered once started, and which could act as a source of continuous free clean energy.

It is within this context that the present invention is provided.

### SUMMARY

The present invention introduces a pioneering pressure-differential engine apparatus, ingeniously designed to exploit the energy potential inherent in the gravitational pressure gradient present in fluid environments. This apparatus leverages the natural phenomenon of pressure differences due to changes in height, transforming this into a practical source of mechanical energy through a highly innovative mechanism.

At the core of this invention is a mechanism that features a closed chain of compressible elements, orchestrated around two coplanar, vertically oriented wheels, all upheld by a rigid frame structure. The operation of the apparatus hinges on the differential pressure encountered by the compressible elements as they traverse various heights within the fluid medium, due to gravitational effects. Elements situated at the upper part of the setup are exposed to lower pressure compared to those at the bottom, prompting them to expand and contract as they move along the designated path of the chain around the wheels.

This differential in pressure induces the dynamic expansion and contraction of the compressible elements, which, in turn, generates thrust, effectively converting the gravitational pressure gradient into rotational motion of the wheels. The invention's design is further optimized by a novel coupling assembly that ensures synchronized rotation of the wheels, thereby enhancing the efficiency of the energy conversion process.

A critical aspect of the invention is the interaction between the compressible elements and the teeth of the wheels as they transition between different depth levels. This unique feature entails the trapping of the compressible elements between the teeth of the wheels, serving to efficiently transfer the energy generated by the pressure-induced expansion and contraction of the elements into the rotational movement of the wheels. Moreover, it safeguards the system's continuous operation by preventing slippage or misalignment of the chain, thereby ensuring a steady and reliable output of energy.

The apparatus showcases several embodiments of the compressible elements, such as corrugated cylinders and pistons with sealed chambers, tailored to maximize operational efficiency across various conditions. Additionally, design elements like flanged rims on the wheels and a gear-based coupling assembly are meticulously incorporated to leverage the pressure-differential induced energy optimally.

By harnessing the ubiquitous natural phenomenon of gravitational pressure gradients in fluid mediums through this sophisticated and innovative mechanism, the invention presents a groundbreaking approach to renewable energy generation. It overcomes the limitations of existing technologies while offering a sustainable and efficient solution for energy production, marking a significant advancement in the field.

The present disclosure provides a pressure-differential engine apparatus that takes advantage of the pressure gradient that occurs with changes in height due to gravitational pull in a fluid environment to generate energy. The engine achieves this by way of a closed chain of compressible elements that is wrapped around and coupled to a set of two coplanar vertically oriented wheels. A rigid frame structure holds the wheels in place with their centres of rotation at a set distance from one another, and a coupling assembly links the rotational motion of the two vertical wheels. The compressible elements at the top experience a different pressure to those at the bottom, causing expansion and contraction of the chain at different points along its length, which in turn generates thrust and rotates the wheels.

According to a first aspect of the present disclosure, there is provided a bicycle-like pressure-differential engine, comprising: a rigid frame structure having a first end and a second end; a first wheel oriented in a vertical plane and rotatably coupled to the frame structure at the first end, the first wheel comprising a plurality of teeth about its circumference; a second wheel oriented in the same vertical plane and rotatably coupled to the frame structure at the second end, such that the axes of rotation of the first and second wheels are parallel, the second wheel comprising a plurality of teeth about its circumference; a coupling assembly connecting the first wheel to the second wheel such that rotation of the first wheel causes corresponding rotation of the second wheel in the same direction, and vice versa, the coupling assembly comprising a set of gears controlling the ratio of rotation between the first and second wheel; and a closed chain of compressible elements, the chain being wrapped tautly about portions of the circumferences of the first and second wheels, and the compressible elements being configured to contract in length in response to increases in external pressure and expand in length in response to decreases in external pressure; wherein the spacing of the compressible elements on the chain is such that the compressible elements become trapped between adjacent teeth of the first and second wheel as the chain is rotated about the wheels.

In some embodiments, the compressible elements comprise corrugated cylindrical floats of identical diameter and length, and which are compressible only along their length.

In some embodiments, the compressible elements comprise cylindrical pistons of identical diameter and length. In such cases, each piston may comprise a connecting rod with a ball jointed end for coupling to an adjacent piston to its rear. Furthermore, each piston may hold a compressible fluid in a sealed chamber. The compressible fluid may be selected to be of lower density than the fluid of the environment of the pressure-differential engine. The frame structure may comprise one or more supporting portions configured support the chain from above.

Alternatively, in some embodiments, each piston holds an incompressible fluid in a sealed chamber, the sealed chamber being in fluid connection with chambers of adjacent pistons via an outlet and inlet, the outlet of each piston being connected by a sealed tube to an inlet of a piston to its rear, such that compression of the piston causes the fluid to flow from the sealed chamber to the chamber of the piston to its rear. The sealed tubes may encompass or be encompassed by the connections between adjacent cylinders. The incompressible fluid may be selected to be of higher density than the fluid of the environment of the pressure-differential engine. In such examples the frame structure may comprise one or more supporting portions configured support the chain from below.

Alternatively, in some embodiments, the compressible elements comprise folded portions of a sealed corrugated hose filled with a compressible fluid.

In some embodiments, one or more of the wheels have flanged rims to hold the chain in place about the circumference.

In some embodiments, the first wheel has a first number of teeth about its circumference, each tooth being separated from adjacent teeth by gaps of a first length, and wherein the second wheel has a second number of teeth about its circumference, each tooth separated from adjacent teeth by gaps of a second length. The first number may be greater than the second number and the first length is less than the second length.

In some embodiments, the coupling assembly comprises a first gear coupled to the first wheel and a second gear coupled to the second wheel, the two gears being linked by a second chain. The relative sizes of the first and second gear may control the ratio of force exerted on the first and second wheels, respectively, by the chain of compressible elements.

In some embodiments, the first wheel and the second wheel are of equal diameter.

In some embodiments, the diameter of the wheels is selected to match the pressure-differential gradient in external fluid in the environment in which the engine is to be located.

In some embodiments, the weight of the wheels and the compressible elements is selected to match the pressure-differential gradient in external fluid in the environment in which the engine is to be located.

In some embodiments, wherein the dimensions of the frame structure are selected to match the pressure-differential gradient in external fluid in the environment in which the engine is to be located.

### BRIEF DESCRIPTION OF THE DRAWINGS

Various embodiments of the invention are disclosed in the following detailed description and accompanying drawings.

FIG. 1 illustrates an isometric perspective view of a first example configuration of a pressure-differential engine according to the present disclosure that utilizes a chain of corrugated floats.

FIG. 2 illustrates an isometric perspective view of a second example configuration of a pressure-differential engine according to the present disclosure that utilizes a chain of sealed pistons filled with a fluid of lower density than the environment of the engine.

FIG. 3 illustrates an isometric perspective view of a third example configuration of a pressure-differential engine according to the present disclosure that utilizes a chain of sealed pistons filled with a fluid of higher density than the environment of the engine.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a,” “an” and “the” are intended to include the plural forms as well, unless the context clearly indicates otherwise.

Spatially relative terms, such as “under,” “below,” “lower,” “over,” “upper” and the like, may be used herein for ease of description to describe one element or feature's relationship to another when the apparatus is right side up.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### Description of Drawings

The present disclosure relates to a pressure-differential engine apparatus designed to generate energy by exploiting the gravitational pressure gradient found in fluid environments. This invention employs a closed chain of compressible elements, arranged around two coplanar, vertically oriented wheels, all supported by a rigid frame structure. The compressible elements undergo expansion and contraction as they move through areas of differing pressure, caused by the gravitational pull on the fluid medium. This movement generates thrust, converting the gravitational pressure gradient into rotational motion of the wheels.

A significant aspect of the invention is the manner in which the compressible elements interact with the teeth of the wheels. As these elements traverse the path defined by the wheels, they are momentarily trapped between the teeth, preventing independent movement and ensuring they act as a single unit. This mechanism maximizes the efficiency of energy conversion by harnessing the full force of the pressure differential across the height of the apparatus.

The invention outlines several embodiments of the compressible elements, including corrugated cylinders and pistons with sealed chambers, to cater to diverse environmental conditions and operational requirements. Additional features, such as flanged rims on the wheels and a gear-based coupling assembly, are incorporated to enhance the apparatus's performance and adaptability.

The operational efficacy of the invention is directly influenced by its height within the fluid medium, with the potential for greater energy generation achieved through maximizing the pressure differential.

In the inventive pressure-differential engine apparatus, the design incorporates an innovative approach to managing the chain of compressible elements, or “containers,” that are integral to its operation. These elements, when engaged with the teeth of the apparatus's vertically oriented wheels, do not behave as individual entities. Instead, they are constrained by the teeth from moving independently, causing them to act as a cohesive unit. This restriction prevents any expansion or contraction of the elements relative to each other, maintaining a constant distance between them until they reach either the apex or base of the wheel's rotation.

This configuration harnesses the full magnitude of the pressure differential between the lower and upper regions of the apparatus. Specifically, the combined effect of the higher pressure at the bottom and the compressive force exerted on the containers at the top propels the entire block of containers. This movement leverages the entire pressure difference experienced across the height of the apparatus, translating it into a powerful motive force.

This mechanism of action ensures that the force generated by the pressure differential is applied primarily at the extremities of the wheel's path-the very bottom and top. As the containers descend on one side, they do so as a unified mass, ensuring that the force exerted on the wheel on one side is less than the total force exerted by the container block on the opposite side. This imbalance facilitates the lifting of the weight on the opposing side, aided by a gear mechanism that adjusts the force ratio. Specifically, a 2:1 gear ratio diminishes the effect of the weight on one side, enhancing the system's efficiency by ensuring that the full pressure force significantly outweighs any uncompensated weight on the other side. Additional modifications, such as tubes connecting corrugated containers, are employed to further optimize the lifting weight, ensuring that the pressure forces are effectively applied to propel the block of containers.

The apparatus's effectiveness is influenced by the height at which it operates, with a greater height yielding a larger pressure difference and thus a stronger motive force, according to Pascal's law. The design's maximum operational height is determined by the fluid medium, with a limit of 10 meters in water and approximately 76 centimeters in mercury, reflecting mercury's higher density.

To accommodate various operational environments and enhance the apparatus's versatility, embodiments with both corrugated elements and piston-based compressible elements are proposed. Additionally, the invention contemplates versions designed for inverse operation, where the device is submerged in a liquid, broadening the scope of applications for this innovative energy-generation technology.

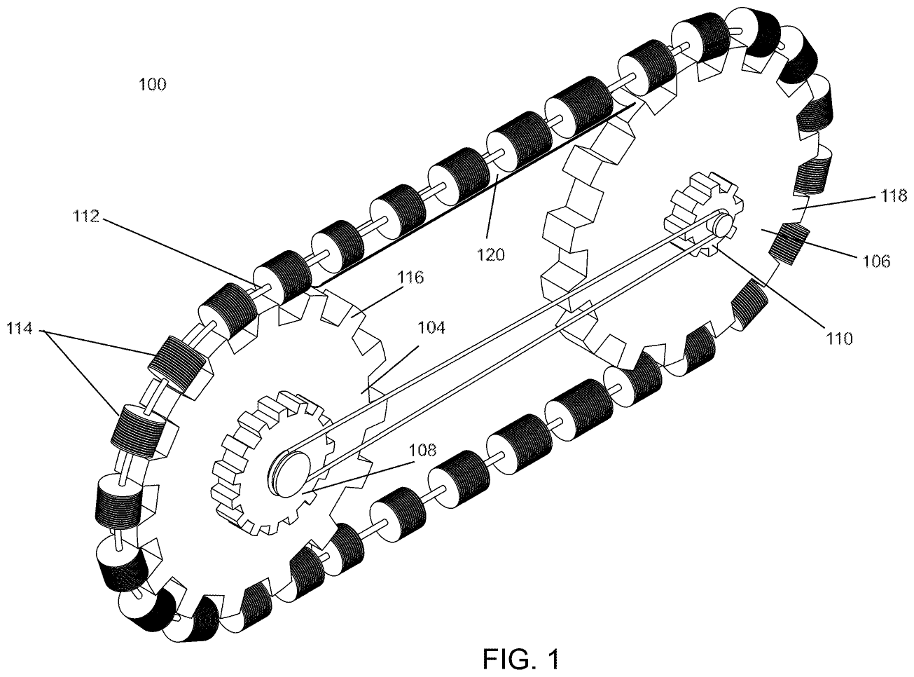

Referring to FIG. 1, an isometric perspective view is shown of a first example configuration of a pressure-differential engine 100 according to the present disclosure.

As can be seen, the pressure-differential engine 100 somewhat resembles a bicycle in shape and structure. It comprises a rigid frame structure (not illustrated, as it can take any necessary form as long as it mounts the wheels in the necessary positions) upon which two vertical, coplanar, toothed wheels 104 and 106 are rotatably mounted, their axes of rotation being parallel with one another, and held a set distance apart from one another by the frame structure.

In the present example, all the wheels are generally approximately the same diameter to simplify the geometry of construction.

The first wheel 104 (on the left) and the second wheel 106 (on the right) are coupled together by a coupling assembly. In the examples given this is a gear assembly comprising a first larger gear 108 attached to the first wheel at its center of rotation and a second smaller gear 110 attached to the right wheel at its center of rotation. The rotation of the two gears is linked, such that rotation of one gear in a first direction causes rotation of the other gear in the same direction, at a ratio corresponding to the size ratio of the two gears. This rotational drive coupling between the gears is transferred to the first and second wheels. For example, if the gear sizes are ate a 2:1 ratio, pressures and forces acting on the first wheel 104 will only affect the second wheel 106 half as much.

The above-described construction is shared across all example configurations of the present disclosure, each of which then also has a closed chain of compressible elements 112 wrapped tautly around the wheels as shown. Some elements could be changed, however—for example an alternative coupling assembly could connect the rotation of the vertical wheels.

In the example of FIG. 1, the compressible elements comprise corrugated floats 114, and the engine 100 is designed to operate in a fluid of high density such as a dense gas or liquid—it could operate underwater for example.

Floats 114 are cylindrical floats of identical diameter and length and which are compressible only along their length. They may comprise reinforcing metal elements about their circumferences to ensure this.

As the surrounding fluid is of greater density at greater depths, i.e. there is greater pressure at the height of the bottom of the two vertical wheels, the floats 114 will be compressed to a shorter length at that depth, which in turn shortens the length of the chain 112, whereas at the upper level, i.e. at the top of the first wheel 104 and second wheel 106, the floats 114 will expand. This change in length, caused by the differential in pressure between the two heights, generates a force that is converted into thrust when the floats 114 reach the bottom and contract.

The teeth 116 of the first wheel and the teeth 118 of the second wheel play a key part in turning this pressure difference into useful energy. When a compressible element in the chain is rotated about to the point where it contacts the wheel (the top/bottom), it will fall into a gap between the teeth, and become lodged there until it has exited the wheel on the opposing side (bottom/top). Thus, the containers that are held between the teeth of the wheels do not act as separate containers, they effectively move as a single block because they are prevented from moving relative to one another by the teeth of the wheel, and cannot expand or contract, the distance between them therefore remaining the same until they come to the top/bottom of the height of the wheel.

By constricting the floats 114 from expanding or contracting during transition between the two depths, the change in length of between two elements of the chain is prevented from occurring until the compressible elements leave the circumference of the vertical wheels.

For the sake of further explanation, let us assume that the wheels are rotating in a clockwise direction. The floats 114 would arrive at and leave the second vertical wheel 110, if the chain and wheels are rotating clockwise would be taking them downwards, in an expanded state. Thus the teeth 118 must be fewer and have greater separation between them to receive and hold the floats 114. The floats then gradually contract as they are pulled along at the lower depth until they arrive at the first vertical wheel 104 in a contracted state, which must therefore have a greater number of teeth 116 separated by smaller gaps.

The frame structure may include supports 120 to keep the portions of chain 112 that hang between the wheels from drooping.

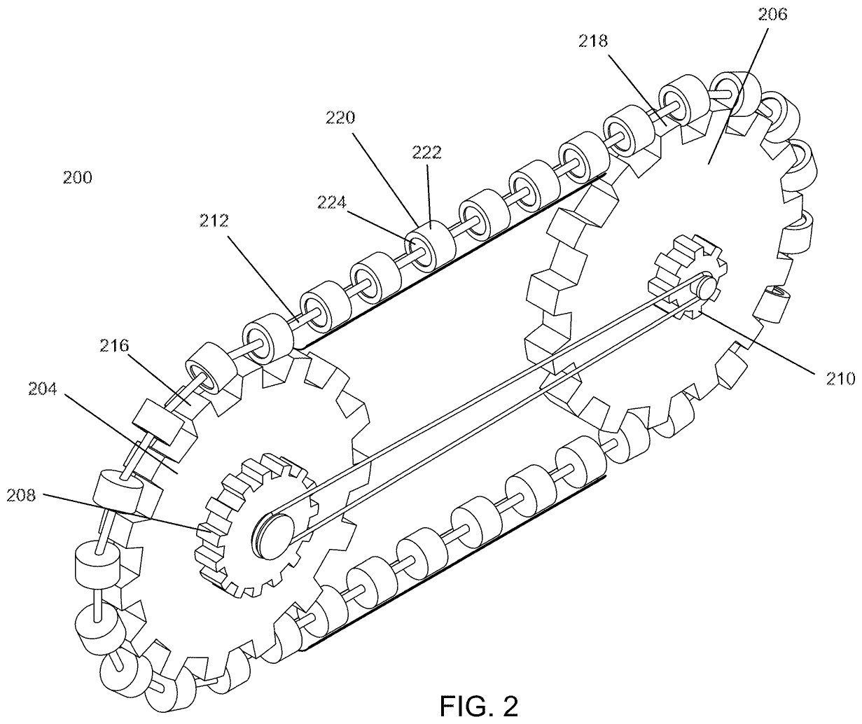

Referring to FIG. 2, an isometric perspective view is shown of a second example configuration of the bicycle-like pressure-differential engine 200 according to the present disclosure.

This configuration uses sealed pistons as compressible elements instead of corrugated floats, and fills the pistons with a compressible fluid that is of lower density than the surrounding environment—thus it is also suitable for operation in dense gas or liquid environments such as underwater.

As mentioned above, the base construction is the same. The first wheel 204 (on the left) and the second wheel 206 (on the right) are coupled together by the gear assembly comprising the first larger gear 208 attached to the first wheel at its center of rotation and the second smaller gear 210 attached to the right wheel at its center of rotation. And a closed chain of compressible elements 212 wrapped tautly around the wheels and between their teeth 216 and 218 as shown.

The pistons 220 are cylindrical, with identical diameter and length. Each piston 220 in the chain 212 comprises an outer part 222 and an inner part 224 that can move axially within the outer part and that together form a sealed chamber filled with compressible fluid. A connecting rod with a ball jointed end extends from the rear of each piston 220 and coupled to a rod extending from the front of the adjacent piston. Other types of connections could also be used—but they cannot be flexible or compressible, so that the only changes in length of chain 212 are caused by the inner parts 224 of the pistons 220 moving with respect to the outer parts 224 during compression or expansion. The working principles of this second example are the same as for the first.

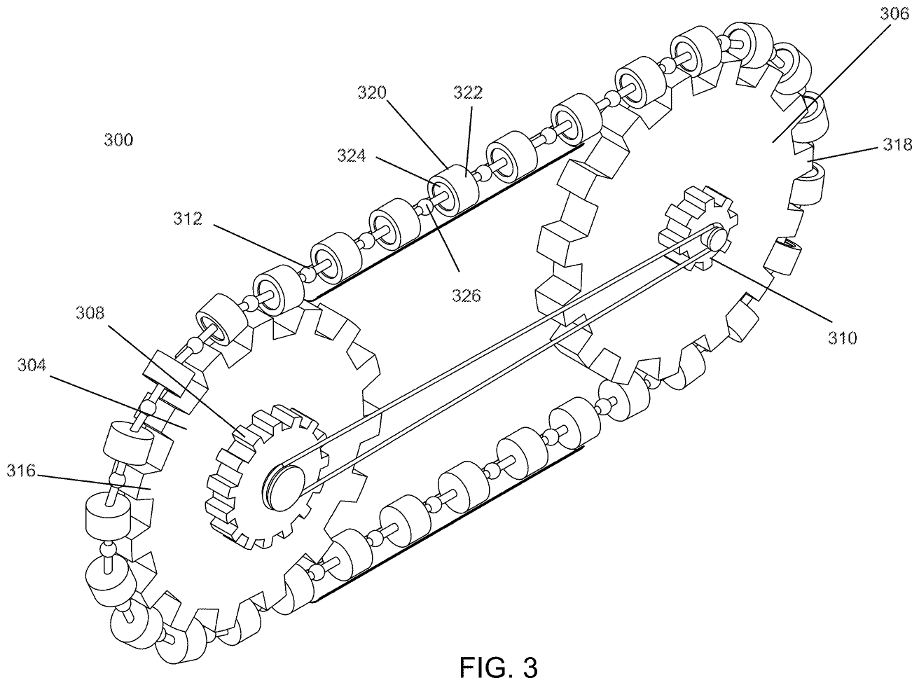

Referring to FIG. 3, an isometric perspective view is shown of a third example configuration of a pressure-differential engine 300 according to the present disclosure.

Again, the base construction is the same. The first wheel 304 (on the left) and the second wheel 306 (on the right) are coupled together by the gear assembly comprising the first larger gear 308 attached to the first wheel at its center of rotation and the second smaller gear 310 attached to the right wheel at its center of rotation. And a closed chain of compressible elements 312 wrapped tautly around the wheels and between their teeth 316 and 318 as shown.

This configuration also uses pistons 320 as the compressible elements, but fills them with an incompressible fluid, i.e. a liquid, which is usually of greater density than the surrounding environment of the engine, and the whole chain 312 is fluidically connected.

In this configuration, instead of the fluid being compressed as the inner part 322 is drawn into the outer part 324 of each piston, the fluid is instead pushed through an outlet of the sealed chamber during compression, and into tube 326 which leads to an inlet for the sealed chamber of an adjacent piston to its rear.

The fluid is thus continuously pushed rearwards in the chain 312 from the point where the pistons descend to the lower height on the second vertical wheel 306. Then as the compressed pistons 320 that have little fluid left inside them exit the first vertical wheel 304 at the upper level and begin expanding, the liquid is drawn into them from the ones in front. The pistons 320 thus gradually fill with fluid and expand as they are drawn along the top level between the first vertical wheel 304 and the second vertical wheel 306 they become ‘full’ again. This means that pistons entering the second vertical wheel 306 from the top level are always heavier than those entering the first vertical wheel 304 from below, which is the source of thrust in this configuration.

This version of the engine 300 can thus work in environments of extremely light fluid, including the air of earth.

Although not shown, another example configuration of the present disclosure utilizes the same base structure but with the chain of compressible elements being a sealed corrugated hose, with the corrugations being compressed and then expanding as it travels about the wheels.

The diameter and weight of the wheels, as well as the dimensions of the frame structure and the arrangement and ratio of the gears may all be selected to match an expected pressure-differential gradient in external fluid in the environment in which the engine is to be located.

The vertical wheels may in some configurations but have flanged rims to hold the chain in place about the circumference as it passes around.

The engine may be made entirely of recyclable material.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A bicycle-like pressure-differential engine, comprising:
a rigid frame structure having a first end and a second end;
a first wheel oriented in a vertical plane and rotatably coupled to the frame structure at the first end, the first wheel comprising a plurality of teeth about its circumference;
a second wheel oriented in the same vertical plane and rotatably coupled to the frame structure at the second end, such that the axes of rotation of the first and second wheels are parallel, the second wheel comprising a plurality of teeth about its circumference;
a coupling assembly connecting the first wheel to the second wheel such that rotation of the first wheel causes corresponding rotation of the second wheel in the same direction, and vice versa, the coupling assembly comprising a set of gears controlling the ratio of rotation between the first and second wheel; and
a closed chain of compressible elements, the chain being wrapped tautly about portions of the circumferences of the first and second wheels, and the compressible elements being configured to contract in length in response to increases in external pressure and expand in length in response to decreases in external pressure;
wherein the spacing of the compressible elements on the chain is such that the compressible elements become trapped between adjacent teeth of the first and second wheel as the chain is rotated about the wheels.

2. A bicycle-like pressure-differential engine according to claim 1, wherein the compressible elements comprise corrugated cylindrical floats of identical diameter and length, and which are compressible only along their length.

3. A bicycle-like pressure-differential engine according to claim 1, wherein the compressible elements comprise cylindrical pistons of identical diameter and length.

4. A bicycle-like pressure-differential engine according to claim 3, wherein each piston comprises a connecting rod with a ball jointed end for coupling to an adjacent piston to its rear.

5. A bicycle-like pressure-differential engine according to claim 3, wherein each piston holds a compressible fluid in a sealed chamber.

6. A bicycle-like pressure-differential engine according to claim 5, wherein the compressible fluid is selected to be of lower density than the fluid of the environment of the pressure-differential engine.

7. A bicycle-like pressure-differential engine according to claim 6, wherein the frame structure comprises one or more supporting portions configured support the chain from above.

8. A bicycle-like pressure-differential engine according to claim 3, wherein each piston holds an incompressible fluid in a sealed chamber, the sealed chamber being in fluid connection with chambers of adjacent pistons via an outlet and inlet, the outlet of each piston being connected by a sealed tube to an inlet of a piston to its rear, such that compression of the piston causes the fluid to flow from the sealed chamber to the chamber of the piston to its rear.

9. A bicycle-like pressure-differential engine according to claim 8, wherein the sealed tubes encompass or are encompassed by the connections between adjacent cylinders.

10. A bicycle-like pressure-differential engine according to claim 8, wherein the incompressible fluid is selected to be of higher density than the fluid of the environment of the pressure-differential engine.

11. A bicycle-like pressure-differential engine according to claim 10, wherein the frame structure comprises one or more supporting portions configured support the chain from below.

12. A bicycle-like pressure-differential engine according to claim 3, wherein the compressible elements comprise folded portions of a sealed corrugated hose filled with a compressible fluid.

13. A bicycle-like pressure-differential engine according to claim 1, wherein one or more of the wheels have flanged rims to hold the chain in place about the circumference.

14. A bicycle-like pressure-differential engine according to claim 1, wherein the first wheel has a first number of teeth about its circumference, each tooth being separated from adjacent teeth by gaps of a first length, and wherein the second wheel has a second number of teeth about its circumference, each tooth separated from adjacent teeth by gaps of a second length.

15. A bicycle-like pressure-differential engine according to claim 14, wherein the first number is greater than the second number and the first length is less than the second length.

16. A bicycle-like pressure-differential engine according to claim 1, wherein the coupling assembly comprises a first gear coupled to the first wheel and a second gear coupled to the second wheel, the two gears being linked by a second chain.

17. A bicycle-like pressure-differential engine according to claim 16, wherein the relative sizes of the first and second gear controls the ratio of force exerted on the first and second wheels, respectively, by the chain of compressible elements.

18. A bicycle-like pressure-differential engine according to claim 1, wherein the first wheel and the second wheel are of equal diameter.

19. A bicycle-like pressure-differential engine according to claim 1, wherein the diameter of the wheels is selected to match the pressure-differential gradient in external fluid in the environment in which the engine is to be located.

20. A bicycle-like pressure-differential engine according to claim 1, wherein the weight of the wheels and the compressible elements is selected to match the pressure-differential gradient in external fluid in the environment in which the engine is to be located.

21. A bicycle-like pressure-differential engine according to claim 1, wherein the dimensions of the frame structure are selected to match the pressure-differential gradient in external fluid in the environment in which the engine is to be located.
